(19) United States
(12) Patent Application Publication
(10) Pub. No.: US 2020/0150238 A1
(43) Pub. Date: May 14, 2020

(54) NON-INTERFERING LONG- AND SHORT-RANGE LIDAR SYSTEMS

(71) Applicant: Continental Automotive Systems, Inc., Auburn Hills, MI (US)

(72) Inventors: Elliot Smith, Carpinteria, CA (US); Heiko Leppin, Hergensweiler (DE); Wilfried Mehr, Wolfurt (AT); Arnaud Lagrandre, Carpinteria, CA (US)

(73) Assignee: Continental Automotive Systems, Inc., Auburn Hills, MI (US)

(21) Appl. No.: 16/683,214

(22) Filed: Nov. 13, 2019

Related U.S. Application Data
(60) Provisional application No. 62/760,071, filed on Nov. 13, 2018.

(51) Int. Cl. G01S 7/481; G01S 7/484; G01S 7/4865; G01S 7/487; G01S 7/4911; G01S 7/4912

(52) U.S. Cl. CPC G01S 7/4813; G01S 7/484; G01S 7/4912; G01S 7/487; G01S 7/4911; G01S 7/4865

(57) ABSTRACT

A lidar sensor assembly includes a first lidar sensor having a first light source configured to generate light at a first wavelength and a first detector configured to receive reflected light at the first wavelength. The lidar sensor assembly also includes a second lidar sensor having a second light source to generate light at a second wavelength and a second detector configured to receive reflected light in the second wavelength. The first wavelength is different from the second wavelength such that interference between the first light source and the second light source is minimized.

### CROSS REFERENCE TO RELATED APPLICATION

This application claims the benefit of provisional patent application No. 62/760,071, filed Nov. 13, 2018, which is hereby incorporated by reference.

### TECHNICAL FIELD

The technical field relates generally to lidar sensors.

### BACKGROUND

Lidar sensors are increasingly seen as a necessary component to autonomous driving of land-based vehicles, e.g., automobiles. While radar sensors can provide a point cloud with velocity, such sensors still provide very poor resolution and may fail to discriminate between very different objects. Optical cameras also have problematic issues, notably in nighttime conditions, where objects are poorly illuminated. Furthermore, cameras are generally unable to provide a long-range distance measurement of objects.

In developing a vehicular sensing strategy for level 3-5 autonomous driving, a first set of requirements may be developed from urban interface driving, where the focus is on short range objects. Particularly, one challenge is movement of an object within a scene of a given frame, due to the object moving relative to the camera (tangentially or radially), in order to form no distortion. Image distortion takes time to deconvolute and time is lacking in an urban interface setting. A second set of requirements for level 3-5 autonomous driving stems from highway driving where long-range, small object detection becomes imperative in order to allow proper braking times at a reasonable deceleration. Typical vehicular lidar systems available today may address one of these set of requirements, but not both.

As such, it is desirable to present a lidar sensor assembly that may provide both long-range and short-range sensing. In addition, other desirable features and characteristics will become apparent from the subsequent summary and detailed description, and the appended claims, taken in conjunction with the accompanying drawings and this background.

### BRIEF SUMMARY

In one exemplary embodiment, a lidar sensor assembly includes a first lidar sensor having a first light source configured to generate light at a first wavelength and a first detector configured to receive reflected light at the first wavelength. The lidar sensor assembly also includes a second lidar sensor having a second light source to generate light at a second wavelength and a second detector configured to receive reflected light in the second wavelength. The first wavelength is different from the second wavelength such that interference between the first light source and the second light source is minimized.

In one exemplary embodiment, a method of operating a lidar sensor assembly includes generating light at a first wavelength with a first light source of a first lidar sensor. The method further includes receiving light at the first wavelength with a first detector of the first lidar sensor. The method also includes generating light at a second wavelength with a second light source of a second lidar sensor. The method further includes receiving light at the second wavelength with a second detector of the second lidar sensor. The first wavelength is different from the second wavelength such that interference between the first light source and the second light source is minimized.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a perspective view of a lidar sensor assembly according to one exemplary embodiment;

FIG. 2 is a perspective view of the lidar sensor assembly according to another exemplary embodiment;

FIG. 3 is a top view of a vehicle with one potential implementation of the lidar sensor assembly;

FIG. 4 is a top view of a vehicle with another potential implementation of a plurality of lidar sensor assemblies;

FIG. 5 is a top view of a vehicle with yet another potential implementation of a plurality of lidar sensor assemblies; and

FIG. 6 is a block diagram of a long-range lidar sensor according to one exemplary embodiment.

### DETAILED DESCRIPTION

Referring to the Figures, wherein like numerals indicate like parts throughout the several views, a lidar sensor assembly 100 is shown and described herein.

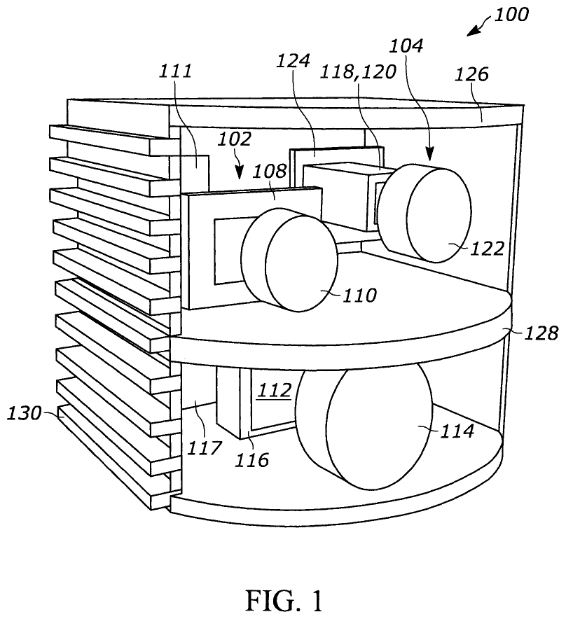

Referring to FIG. 1, the assembly 100 includes a first lidar sensor 102 and a second lidar sensor 104. The first lidar sensor 102 may be referred to as a short-range lidar sensor 102 and the second lidar sensor 104 may be referred to as a long-range lidar sensor 104.

In one exemplary embodiment, as described below, the first lidar system 102 is a time of flight device having a global shutter implemented by flash lidar or quasi-flash lidar techniques. The first lidar system 102 is fully solid-state, i.e., includes no moving parts.

The first lidar sensor 102 includes a first light source 108 (i.e., a transmitter) configured to generate light and a first detector 112 (i.e., a receiver) configured to receive light reflected off one or more objects (not shown) in a field of view (not numbered) of the sensor 102. In one exemplary embodiment, the horizontal field of view is between 100° and 180° and the vertical field of view is between 30° and 180°. However, it should be appreciated that other dimensions for the field of view may be implemented.

In one embodiment, the first light source 108 may include a laser (not separately numbered). The laser may be implemented with a diode-pumped solid-state laser. However, it should be appreciated that other lasers and/or other light sources may be utilized to implement the first light source 108. In another embodiment, the laser may be a vertical cavity surface emitting laser (“VCSEL”), a VCSEL array, a fiber laser, an edge emitter laser (“EEL”), or an EEL array. In one embodiment, the light provided by the first light source 108 is non-coherent.

The first light source 108 is configured to generate light at a first wavelength in a first range of wavelengths. In the exemplary embodiment, the first range of wavelengths is between 800 and 1100 nanometers (“nm”). In some exemplary embodiments, the first wavelength of light may be between 900 nm and 950 nm or between 1000 nm and 1100 nm. In yet more exemplary embodiments, the first wavelength of light may be 905, 940, or 1064 nm. Of course, the first light source 108 may generate light at other wavelengths.

In the exemplary embodiment, the first lidar sensor 102 includes transmit optics 110 coupled to the first light source 108 and configured to distribute light generated by the first light source into a field of illumination corresponding to the field of view of the sensor 102. The first lidar sensor 102 of the exemplary embodiment includes a printed circuit board 111 coupled to the first light source 108. In exemplary embodiments, the printed circuit board 111 includes all electronics needed to drive, communicate, diagnose and in some cases, temperature regulate the first lidar source 108.

The first detector 112 may be implemented with an array of photodetectors (not individually shown). The photodetectors may be implemented with, for example, PIN photodiodes, avalanche photodiodes (“APDs”), and/or single photon avalanche photodiodes (“SPADs”). In the exemplary embodiment, the first lidar sensor 102 includes receive optics 114 coupled to the first detector 112 and configured to distribute light received from the field of view onto the first detector 112. An integrated circuit 116 may be electrically connected to the photodetectors of the first detector 112 to receive and/or process electrical signals generated by the photodetectors. In one specific embodiment, the first detector 112 is physically separated from the first light source 108, however other arrangements are possible. An integrated circuit 116 may be placed on a printed circuit board 117 in order to handle communication with other components or functions of the system.

In one embodiment of operation, the first light source 108 of the first lidar sensor 102 may generate one or more pulses of light to illuminate all or part of the field of illumination per frame. In other words, single pulses or a train of pulses may be emitted to illuminate all or part of the field of illumination. The light may reflect off one or more objects in the field of illumination and back to the receive optics 114 and to the first detector 112. The first detector 112, in concert with the integrated circuit 116, may generate an image of the field of view with each photodetector corresponding to one pixel of the image.

The image may be generated by one pulse of light from the first light source 108 or multiple pulses of light from the first light source 108. For example, the first light source 108 may illuminate different sections of the field of view and the resultant reflections may make up the final image.

In one exemplary embodiment, the horizontal and vertical resolution of the image of the first lidar system 102 is higher than 0.5° per pixel. In another exemplary embodiment, the horizontal and vertical resolution of the image is higher than 0.3° per pixel.

A photodiode (not shown), separate from the photodetectors of the first detector 112, may be coupled to the first light source 108 to sense when each pulse of light is generated by the first light source 108, namely for an embodiment utilizing a DPSSL or fiber laser. The photodiode may be electrically connected to the integrated circuit, and, as such, the integrated circuit or other microprocessor may calculate the time elapsed between the pulse of light and any light reflected off objects in the field of view. Thus, the distance to each object may be calculated by the integrated circuit 116 or other microprocessor. As such, the first lidar sensor 102 may be referred to as a time of flight sensor. In another embodiment the zero time can be determined from the signal sent to the driver of the first light source 108, namely for the embodiment considering a direct illumination source as a VCSEL, EEL of array of VCSELs, or EELs

The second lidar sensor 104 includes a second light source 118 configured to generate light and a second detector 120 configured to receive light reflected off one or more objects in a field of view of the sensor 104. In one exemplary embodiment, the horizontal field of view is between 40° and 110° and the vertical field of view is between 10° and 25°. However, it should be appreciated that other dimensions for the field of view may be implemented. In one embodiment, the second lidar sensor 104 is a frequency modulated continuous wave sensor as described in further detail below.

In one embodiment, the second light source 118 may include at least one laser (not separately numbered). The laser may be implemented with a sample grating distributed Bragg reflector laser, an external cavity diode laser, a distributed feed back laser, a vertical cavity diode laser, and/or a cantilevered cavity laser. Of course, other lasers or light sources may be utilized to implement the second light source 118.

The second light source 118 is configured to generate light at a second wavelength in a second range of wavelengths. In the exemplary embodiment, the second range of wavelengths is between 1230 and 1600 nm. Of course, the second light source may generate light at other wavelengths. The laser of the second light source 118 may be tuned to operate within ±40 nm from a center wavelength. In another embodiment, the bandwidth of any given sweep may be between 1 and 5 nm. In this case, wavelength steering is difficult and a MEMS steering may be utilized instead.

The second lidar sensor 104 may utilize a scanning device (not numbered) to direct light produced by the second light source 118 in a field of illumination. The scanning device may be implemented with at least one of an optical phase array (“OPA”), a micro-electromechanical system (“MEMS”), a micro-actuated mirror system, a liquid crystal display (“LCD”), and/or a metamaterial. In one embodiment, the directing of the light by the scanning device may be fully mechanical. In another embodiment, the directing of the light may be achieved by frequency and/or phase. In yet another embodiment, the directing of the light in one axis may be achieved mechanically, while the directing of the light along the other axis may be achieved by frequency and/or phase.

The second detector 120 is configured to receive light reflected from one or more objects in the field of view at the second wavelength in the second range of wavelengths. In one exemplary embodiment, the second detector 120 is based on germanium (“Ge”). In another embodiment, the second detector 120 is based on germanium on silicon (“Ge-on-Si”). In yet another embodiment, the second detector 120 is based on indium gallium arsenide (“InGaAs”).

The second lidar sensor 104 is further configured to generate a foveated field of view along at least one axis to increase the resolution of a certain segment of the total field of view in order to resolve small objects without over burdening the sensor 104. In one exemplary embodiment, the horizontal and vertical resolution is less than 0.06° with a foveated resolution of less than 0.04°. In another embodiment, the foveated resolution is less than 0.015°.

The first wavelength, utilized by the first lidar sensor 102, is different from the second wavelength, utilized by the second lidar sensor 104, such that interference between the first lidar sensor and the second lidar sensor is minimized. In one exemplary embodiment, the first detector 112 of the first lidar sensor is based on silicon. By utilizing silicon, the first detector 112 is unable to detect wavelengths greater than 1100 nm, such as those produced by the second light source 118. As such, interference between the sensors 102, 104 is minimized or completely eliminated. As stated above, the second detector 120 of the second lidar sensor 104 is based on Ge, Ge-on-Si, or InGaAs. By utilizing Ge, Ge-on-Si or InGaAs the second detector is unable to detect wavelengths less than 1000 nm, such as those produced by the first light source 108. Additionally, the second lidar sensor 104 functioning on the basis of coherent light, will inherently be immune to light emitted from the first lidar sensor 102.

In an exemplary embodiment, the first lidar sensor 102 is a short-range sensor capable of detecting objects within 70 meters (“m”) of the first detector and low reflecting objects of ten percent Lambertian within 30 m, more specifically within 20 m. The second lidar sensor is a long-range sensor capable of detecting objects within 250 m of the second detector and low reflecting objects of ten percent Lambertian within 200 m, more specifically 150 m. However, it should be appreciated that other maximum and minimum detection distances may be contemplated for the sensors 102, 104.

In the exemplary embodiment of FIG. 1, each of the systems 102, 104 is disposed within a single housing 126. An optical barrier 128 is disposed within the housing 126 to separate the first light source 108 and optics 110 of the first lidar sensor 102 from the first detector 112 and optics 114 of the first lidar sensor 102. The housing 126 may define ribs 130 or other mechanisms to dissipate heat. The assembly 100 may include a cover (not shown) to further enclose the systems 102, 104 within the housing 126.

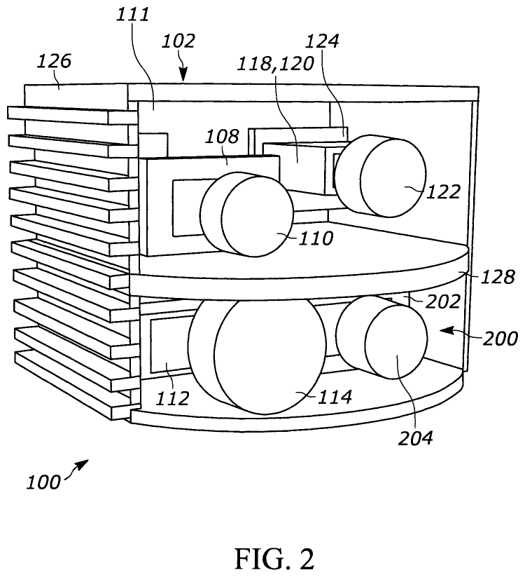

FIG. 2 shows another exemplary embodiment of the lidar sensor assembly 100. In this embodiment, the assembly 100 further includes a camera system 200 in addition to the first and second lidar sensors 102, 104 described above. The camera system 200 includes a receiver (e.g., a photodetector array) 202 and associated optics 204. The camera system 200 is also disposed in the single housing 126.

It should be appreciated that the first and second lidar systems 102, 104 may be disposed in completely separate housings (not shown). In such an example, a central processing unit (“CPU”) (not shown) may be utilized to control both systems 102, 104. The CPU may be disposed in one of the separate housings or remote from each housing.

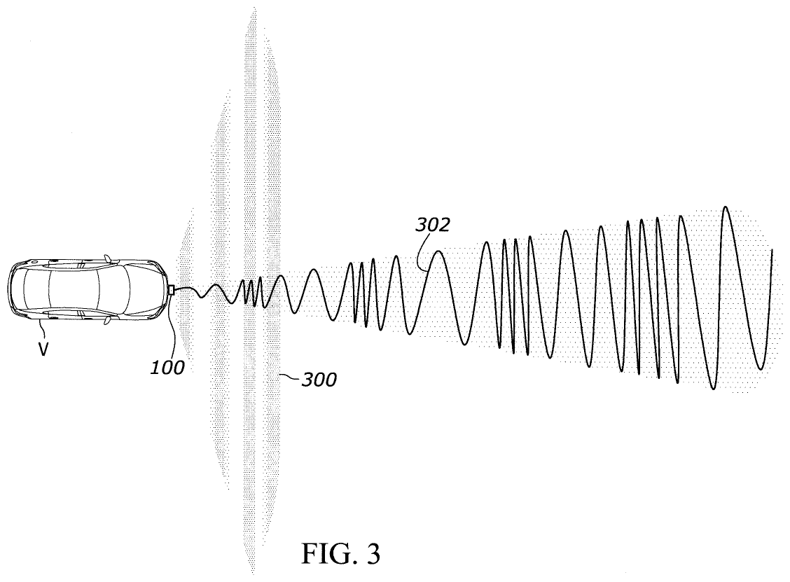

FIG. 3 shows a short-range field of view 300 of the first lidar sensor 102 and a long-range field of view 302 of the second lidar sensor 104, according to one exemplary embodiment where a single lidar sensor assembly 100 is employed on a vehicle V. A CPU 304 in communication with each lidar assembly 100 may be utilized to coordinate control functions, as well as to combine images provided by each assembly 100.

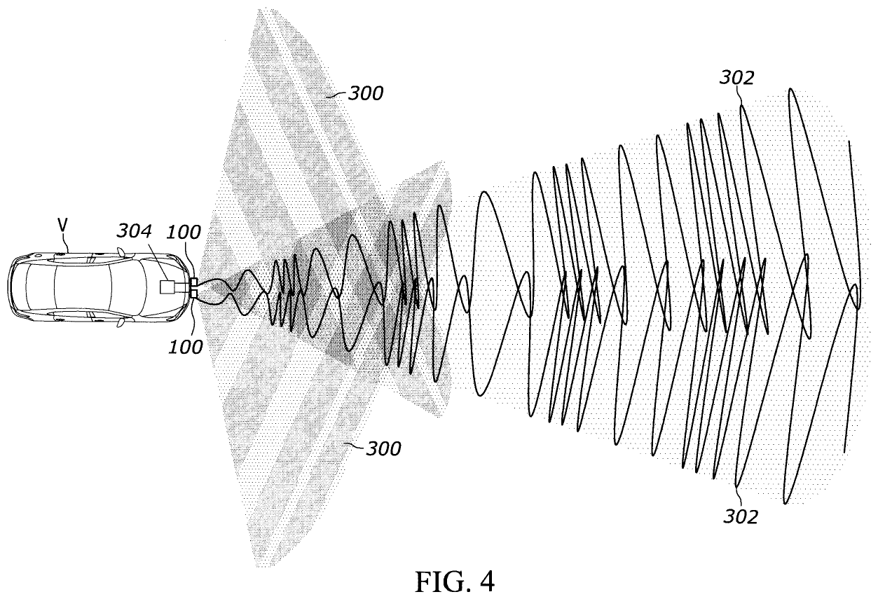

FIG. 4 shows an exemplary embodiment where multiple lidar sensor assemblies 100 are utilized, both in the front of a vehicle V. In this exemplary embodiment, the short-range field of views 300 overlap one another and the long-range field of views 302 overlap one another. As such, the lidar sensor assemblies 100 may provide complete and uninterrupted coverage of the area in front of the vehicle.

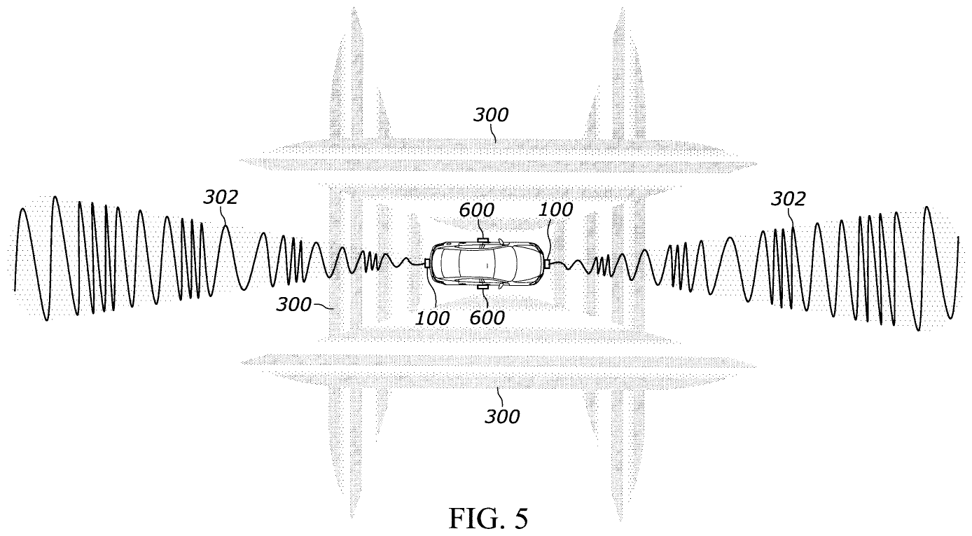

FIG. 5 shows an exemplary embodiment where multiple short and long-range lidar sensor assemblies 100 are utilized, both in the front and rear of a vehicle V, combined with multiple short-range lidar sensor assemblies 500. In this exemplary embodiment the combination of the short-range fields of views 300 and the long-range fields of view 302 of the short and long-range lidar assemblies 100 overlap the short-range fields of views 300 of the short-range lidar assemblies 500. As such, the lidar sensor assemblies 100 and 500 may provide a complete and uninterrupted coverage of the entire 360° view of the vehicle V.

Other combinations of lidar sensor assemblies 100, 500 may be further contemplated. For instance, 360° coverage around the vehicle V may be provided utilizing only one short- and long-range lidar sensor assembly 100, coupled to the front of the vehicle, while short-range lidar sensor assemblies 500 are coupled to each side of the vehicle V.

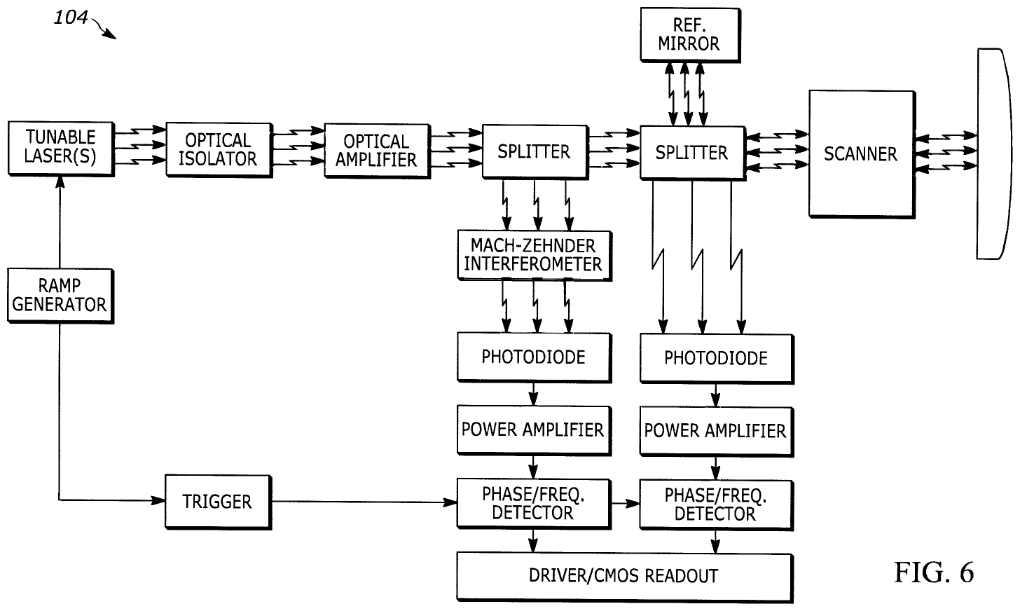

FIG. 6 shows a block diagram of one exemplary embodiment of the second lidar sensor 104. The second lidar sensor 104 in this embodiment may include a transmitter unit (not numbered) whose output frequency, amplitude, or phase may be swept, using current, voltage, or temperature, over multiple nanometers. The second light source 118 of the second lidar sensor 104 may include a single laser source or multiple laser sources.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A lidar sensor assembly, comprising:
a first lidar sensor including a first light source configured to generate light at a first wavelength and a first detector configured to receive reflected light at the first wavelength; and
a second lidar sensor including a second light source to generate light at a second wavelength and a second detector configured to receive reflected light in the second wavelength;
wherein the first wavelength is different from the second wavelength such that interference between the first light source and the second light source is minimized.

2. The lidar sensor assembly as set forth in claim 1 wherein the first wavelength is less than 1100 nanometers and the second range of wavelengths is greater than 1100 nanometers.

3. The lidar sensor assembly as set forth in claim 2 wherein said first detector is based on silicon.

4. The lidar sensor assembly as set forth in claim 3 wherein said second detector is based on at least one of indium gallium arsenide, germanium, and germanium on silicon.

5. The lidar sensor assembly as set forth in claim 2 wherein the first wavelength is between 800 and 1100 nanometers.

6. The lidar sensor assembly as set forth in claim 2 wherein the second wavelength is between 1230 and 1600 nanometers.

7. The lidar sensor assembly as set forth in claim 1 wherein said first lidar sensor is a short-range sensor capable of detecting objects within 30 meters of said first detector and said second lidar sensor is a long-range sensor capable of detecting objects within 150 meters of said second detector.

8. The lidar sensor assembly as set forth in claim 1 wherein said first lidar sensor is a time of flight sensor and said second lidar sensor is a frequency modulated continuous wave sensor.

9. The lidar sensor assembly as set forth in claim 8, wherein said first lidar sensor is a flash lidar sensor.

10. The lidar sensor assembly as set forth in claim 9, wherein said second lidar sensor is a multi-channel frequency modulated continuous wave sensor.

11. The lidar sensor assembly as set forth in claim 10 wherein the first wavelength is less than 1100 nanometers and the second range of wavelengths is greater than 1100 nanometers.

12. The lidar sensor assembly as set forth in claim 11 wherein said first detector is based on silicon.

13. The lidar sensor assembly as set forth in claim 12 wherein said second detector is based on at least one of indium gallium arsenide, germanium, and germanium on silicon.

14. The lidar sensor assembly as set forth in claim 12 wherein the first wavelength is between 800 and 1100 nanometers.

15. The lidar sensor assembly as set forth in claim 12 wherein the second wavelength is between 1230 and 1600 nanometers.

16. The lidar sensor assembly as set forth in claim 1 wherein said first lidar sensor is a short-range sensor capable of detecting objects within 30 meters of said first detector and said second lidar sensor is a long-range sensor capable of detecting objects within 150 meters of said second detector.

17. The lidar sensor assembly as set forth in claim 1, wherein said first lidar sensor operates in a non-coherent pulse, time of flight fashion and the second lidar sensor operates in a coherent frequency modulated fashion.

18. A method of operating a lidar sensor assembly, comprising:
generating light at a first wavelength with a first light source of a first lidar sensor;
receiving light at the first wavelength with a first detector of the first lidar sensor;
generating light at a second wavelength with a second light source of a second lidar sensor; and
receiving light at the second wavelength with a second detector of the second lidar sensor;
wherein the first wavelength is different from the second wavelength such that interference between the first light source and the second light source is minimized.
